(19) United States
(12) Patent Application Publication
(10) Pub. No.: US 2025/0325444 A1
(43) Pub. Date: Oct. 23, 2025

(54) SYSTEM AND METHOD FOR ACUPUNCTURE TREATMENT

(71) Applicant: ACUPUNCTURE MOXA PRO INC., Punta Gorda, FL (US)

(72) Inventor: Ken Gia Nguyen, San Bernardino, CA (US)

(21) Appl. No.: 19/173,158

(22) Filed: Apr. 8, 2025

Related U.S. Application Data
(60) Provisional application No. 63/635,963, filed on Apr. 18, 2024.

(51) Int. Cl. A61H 39/02; A61H 39/00; A61H 39/08

(52) U.S. Cl. CPC A61H 39/02; A61H 39/002; A61H 39/086; A61H 2201/5076

(57) ABSTRACT

A method and apparatus for correctly identifying an acupuncture strategic point comprises a clinician using a probe connected to an electrical driver to apply a pulsed electric current to a patient's skin, establishing electrical continuity between the patient and the clinician so that both the patient and the clinician can sense the pulsed electric current, moving the probe over the patient's skin and monitoring changes in the sensed pulsed electric current, and determining the strategic point to be a point at which irritation from the pulsed electric current as sensed by the clinician is minimized.

### CROSS REFERENCE TO RELATED APPLICATIONS

This application claims the benefit of U.S. Provisional Application No. 63/635,963, filed on 2024 Apr. 18, the contents of which are expressly incorporated by reference herein.

### BACKGROUND

The present disclosure relates to the field of acupuncture treatment, and more specifically precisely identifying acupuncture treatment locations.

Acupuncture involves the insertion of very thin needles through a patient's skin at strategic points on a patient's body. Acupuncture is most commonly used to treat pain, but is also used for overall wellness, including stress management. Acupuncture is a technique for balancing the flow of energy or life force—known as chi or qi (chee)—flowing through pathways (meridians) in a patient's body. By inserting needles into specific strategic points along these meridians, a patient's energy flow will re-balance.

Although the strategic points for needle insertion are in generally similar locations in the human body, the precise location of any given strategic point differs somewhat from person to person. Thus, a seasoned acupuncturist must begin at the general area of each strategic point and use methods such as skin palpitation to identify the precise location of that strategic point in order to insert a needle at the ideal position. This operation is time-consuming and subject to error.

### SUMMARY

The present disclosure teaches a method and apparatus for correctly identifying an acupuncture strategic point in order to improve acupuncture treatment effectiveness and speed. A clinician can apply an energized probe to a patient's skin at an estimated location within a zone likely to include the desired strategic point. The clinician will also establish an electric connection with the patient, such as by holding the patient's hand. As such, a pulsed electric current applied by the probe to the patient will also be sensed by the clinican's hand. The clinician will move the probe over the patient's skin around within the zone, paying close attention to the characteristics of the sensed pulsed electric current as detected by her hand. When the characteristics of the sensed pulsed electric current change to be smoother and less irritating to the clinician and patient, the clinician can be confident that the strategic point has been correctly and precisely located. Further acupuncture treatment can then proceed, and/or the clinician can mark the strategic point and use a similar iterative process to precisely identify other strategic points.

In accordance with one embodiment, the present specification provides a method of identifying an acupuncture treatment strategic point. The method comprises applying a probe to a patient's skin at a first approximate point, applying an applied electric current to the first approximate point via the probe, establishing electrical continuity between a clinician and the patient's skin so that the clinician can detect a sensed electric current portion of the applied electric current flowing from the patient to the clinician, determining from the sensed electric current that the first approximate point is not a first strategic point, moving the probe to a second approximate point, and determining from the sensed electrical current that the second approximate point is the first strategic point.

In some variations, establishing contact between a clinician and the patient's skin comprises the clinician holding a hand of the patient.

Once the location of the first strategic point has been identified, a first acupuncture needle can be applied at the first strategic point.

Some variations can additionally comprise attaching a first electrode to the first acupuncture needle and applying a stimulation current from an electrical stimulation instrument to the first acupuncture needle via the first electrode.

In some variations, once the location of the first strategic point has been identified, a first marker can be applied to the first strategic point. Later, a first acupuncture needle can be applied at the first precise needle site.

Some variations can additionally comprise applying the probe at a third approximate point, and determining from the sensed electrical energy that the third approximate point is a second strategic point. A second marker can be applied to the second strategic point.

Some such variations can additionally comprise removing the first marker from the first strategic point and placing a first acupuncture needle at the first strategic point, and removing the second marker from the second strategic point and placing a second acupuncture needle at the second strategic point.

In some variations, the applied electric current comprises a pulsed electric current.

Some variations can comprise modifying a frequency of the pulsed electric current.

Additional variations can comprise modifying an intensity of the pulsed electric current.

### BRIEF DESCRIPTION OF THE DRAWINGS

FIG. 1 is a perspective view of an embodiment having features as disclosed herein;

FIG. 2 is a partial view of a probe portion of the embodiment of FIG. 1;

FIG. 3 shows the arrangement of FIG. 2 with a covering on a tip of the probe portion;

FIG. 4 is a schematic view depicting the embodiment of FIG. 1 during use, with the probe tip close but spaced from a strategic point;

FIG. 5 shows the arrangement of FIG. 4 at a further stage of use in which the probe tip has located the strategic point;

FIG. 6 is a block diagram depicting electrical flow in accordance with an embodiment; and

FIG. 7 is a schematic view depicting performance of electro acupuncture treatment.

### DESCRIPTION

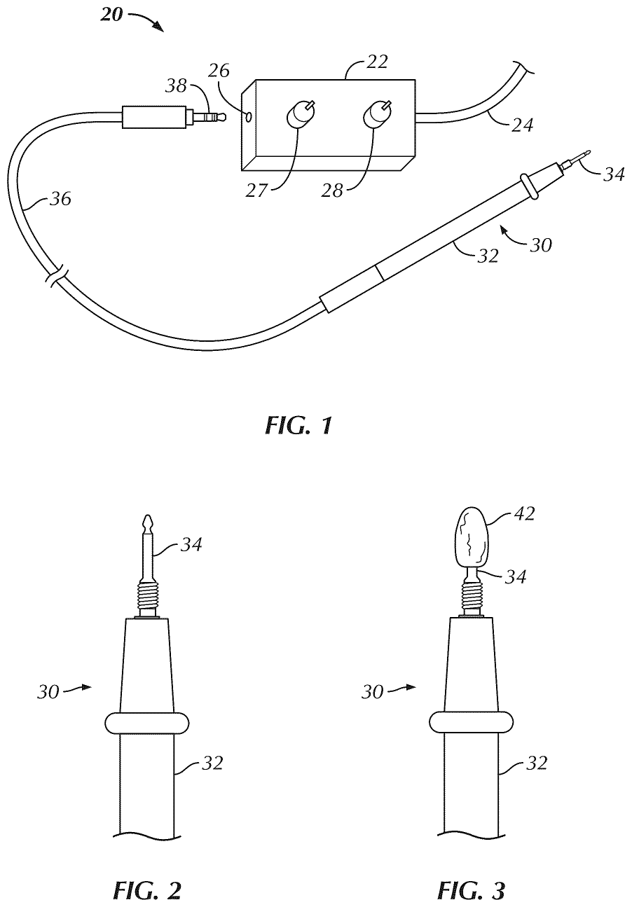

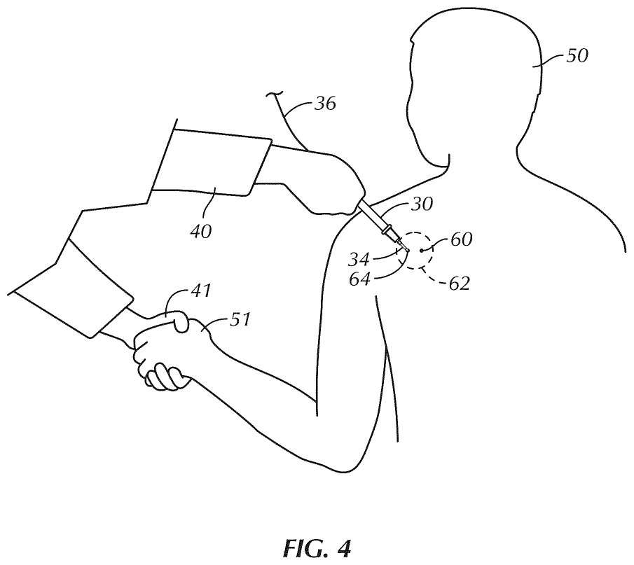

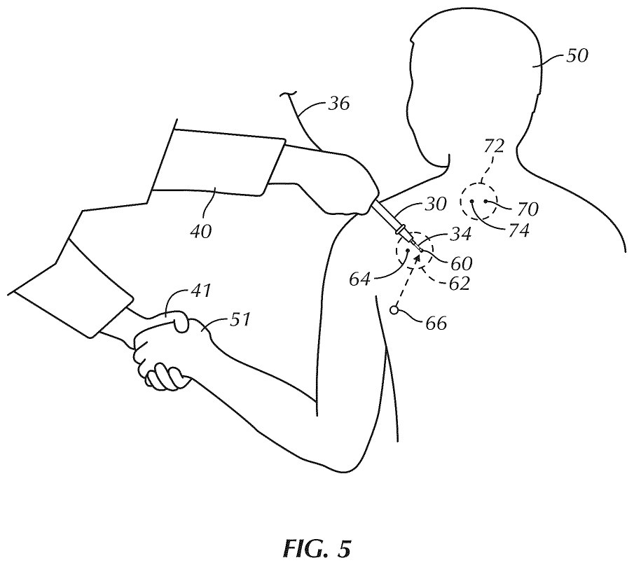

The present disclosure teaches a method and apparatus for correctly identifying an acupuncture strategic point in order to improve acupuncture treatment effectiveness and speed. The apparatus includes a driver 22 (FIG. 1) configured to deliver a pulsed electric current to a handheld probe 30, and specifically to the probe tip 34 (FIG. 1). A first strategic point 60 (FIG. 4) for acupuncture treatment can be expected to be located within a first zone 62 on the patient's 50 skin. A clinician 40 (FIG. 4) seeking to precisely locate the first strategic point 60 will apply the energized probe tip 34 to a patient 50 skin within the first zone 62, such as at a first estimated point 64 (FIG. 4) within the first zone 62. Also, the clinician 40 will establish skin-to-skin contact with the patient 40 such as by engaging hands 41,51 (FIG. 4). In this way, an electric circuit delivers the pulsed electric current applied to the patient to the clinician's hand 41, and the clinician 40 can sense the pulsed electric current. The clinician 40 can then move the probe tip 34, while paying attention to changes in the sensed electric current. When the probe tip 34 gets to the first strategic point 60 (see FIG. 5), it is expected that the sensed electric current detected by the clinician 40 will change to become smoother and less irritating to both patient 50 and clinician 40. In this manner, the clinician 40 can be confident that the first strategic point 60 (FIG. 5) has been correctly and precisely located. Treatment can then proceed, such as by applying an acupuncture needle 44 (FIG. 7) alone or in conjunction with an electro acupuncture apparatus 88 (FIG. 7). Also, rather than proceed immediately with treatment, a first marker 66 (see FIG. 5) can be placed at the first strategic point 60 and the clinician can move on to identifying further strategic points, such as a second strategic point (FIGS. 5, 7) using the same iterative process.

With initial reference to FIG. 1, an acupuncture treatment point location system 20 comprises a driver 22 configured to receive input power from an input power cord 24. The input power can be typical supply power such as 120 VAC. The driver 22 is configured to condition the input power into a pulsed electrical output current suitable for safe application to the skin of a patient, such as a human patient. Such pulsed electrical output can be delivered to and accessed at a cord receiver 26. In the illustrated embodiment, an intensity knob 27 enables adjustment of a voltage of the pulsed output current, and a frequency knob 28 enables the clinician to adjust the pulsing frequency of the pulsed output current.

A probe 30 comprises an elongated handle 32 and a conductive distal probe tip 34. A probe wire 36 extends from a proximal end of the probe 30 and terminates at a connector 38 that is configured to selectively engage with the cord receiver 26. As such, the pulsed electric current emitted by the driver 22 can be communicated to the conductive tip 34 of the probe 30 via the cord receiver 26, connector 38 and probe wire 36.

With reference next to FIG. 2, the tip 34 preferably is electrically conductive and is shaped so as to precisely yet comfortably contact a patient's skin. As such, the tip 34 is rounded so as to avoid abrading the skin. With additional reference to FIG. 3, in some instances a tip covering 42 can be applied to the tip 34. In one variation the tip covering 42 comprises wrapping the tip 34 with cotton, which cotton can be dipped in alcohol so as to preserve electrical conductivity.

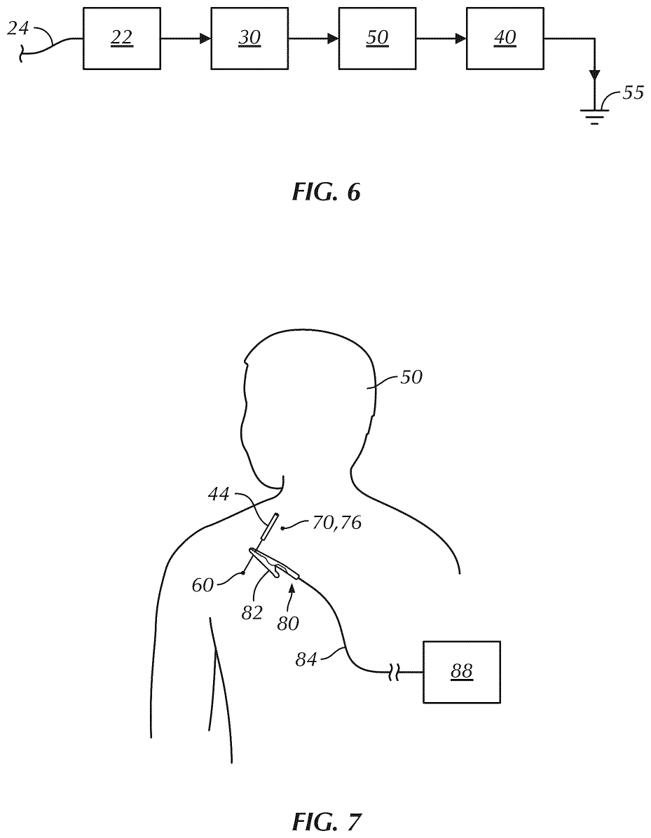

With reference next to FIGS. 4-6, a clinician 40 practicing acupuncture upon a patient 50 desires to identify the most effective strategic points at which to apply an acupuncture needle 44 (see FIG. 7). However, while strategic acupuncture points are in generally similar locations from person to person, the exact, or most precise and effective, location of each strategic point varies somewhat from person to person. Thus, in operation, a clinician desiring to place a needle 44 at a first strategic point 60 will first identify a first zone 62 of the patient's body in which the first strategic point 60 is most likely to be located. The clinician 40 can then apply the probe tip 34 at a first approximate location 64 in the first zone 62 and energize the tip 34 so as to apply the pulsed electric current to the patient's skin at the first approximate location 64. The clinician 40 can then engage his own hand 41 with a free hand 51 of the patient 50. As such, and with specific reference to FIG. 6, an electric circuit is formed from the input power 24 to the device driver 22, which provides the pulsed electric current to the probe 30, then to the patient 50, next to the practitioner 40 and then to ground 55.

When the probe 30 is energized and applying the pulsed electric current to the patient's skin, the patient 50 will, of course, sense the pulsed electric current. A seasoned clinician 40 with a hand 41 engaged with the patient's hand 51 will also feel/sense the pulsed electric current. Movement of the probe tip 34 around and near the first approximate location 64 can result in changes to the sensed pulsed current as detected by both the clinician 40 and the patient 50.

Generally speaking, due to the nature of acupuncture meridians, the pulsed electrical current is best dispersed and most effective in treatment when accurately placed at the first strategic point 60, and the character or nature of the sensed pulsed electric current is more comfortable and therapeutic when correctly applied at the first strategic point 60 than when incorrectly applied at another location—even a nearby location. For example, when the probe tip 34 is placed at the first approximate location 64 (which may be within the first zone 62 but spaced from the first strategic point 60), it can be expected that the patient experiences significant discomfort due to the pulsed electric current. The clinician 40, through which the current flows due to the clinician's hand 41 being engaged with the patient's hand 51, also senses this pulsed electric current. When the probe tip 34 is moved so as to be correctly placed at the first strategic point 60, however, discomfort to the patient 50 reduces substantially, and correspondingly the clinician 40 can detect the difference in the sensed current, which will feel smoother and less uncomfortable.

In view of these considerations, to correctly identify a first strategic point 60 for acupuncture treatment, a clinician 40 may first identify a first zone 62 in which the first strategic point 60 can be expected to be found and may apply the probe tip 34 to a first approximate location 64 within the first zone 62, as depicted in FIG. 4. When the pulsed electric current is applied, the clinician 40, through his hand 41, which is engaged with a hand 51 of the patient 50, senses and notes the character of the pulsed electric current. The clinician 40 then moves the probe tip 43 to a second location, preferably within the first zone 62, and senses the character of the pulsed electric current. This process proceeds iteratively until the clinician 40 determines an optimum location at which the sensed pulsed electric current is most comfortable. This optimum location is determined to be the first strategic point 60 (see FIG. 5).

Once the first strategic point 60 is identified, treatment options can be pursued. For example, an acupuncture needle 44 (see FIG. 7) can be applied at the first strategic point 60. Also, continued application of the pulsed electric current using the probe 30 held so that the probe tip 34 remains at the first strategic point 60 can be used for electrical therapy. Further, a first marker 66 (see FIG. 5) can be applied at the first strategic point 60, and the clinician can proceed to find a second strategic point 70 in an effort to treat multiple strategic points of the patient 50 simultaneously.

Continuing with reference to FIG. 5, similar to finding the first strategic point 60, the clinician can identify a second zone 72 in which the second strategic point 70 can be expected to be located, and can use the probe tip 34 to apply the pulsed electric current to a second approximate location 74 within the second zone 72. Through iterative movement of the probe tip 34 while sensing the pulsed electric current through a hand 41 engaged with the patient's hand 51, the clinician 40 can identify the second strategic point 70 as the point of optimum, smooth, least-irritating character of the pulsed electric current. A needle 44, a second marker 76 (see FIG. 7), or continuous application of the pulsed electric current can be applied to the identified second strategic point 70 as desired.

With reference next to FIG. 7, in one variation, an acupuncture needle 44 can be applied at the first strategic point 60 and an electroacupuncture electrode 80 can be applied to the needle 44. The electrode 80 can comprise a clip 82, such as an alligator-type clip configured to releasably and conductively attach to the needle 44, and a wire 84 that can be connected to an electro stimulation instrument 88 such as a microcurrent electrical neuromuscular stimulator (MEMS) device. As such, pulsed electrical stimulation can be applied to the patient 50 at the first strategic point 60 via the needle 44 in order to perform electroacupuncture. Notably, a needle, and associated electrode, can also be applied at the second strategic point 70 (shown in FIG. 7 marked by a second marker 76) to enable simultaneous treatment at the first and second strategic points 60, 70. In fact, any number of strategic points can be simultaneously treated as desired.

As discussed above, the clinician 40 can complete the electric circuit by clasping hands 41, 51 with the patient 50. It is to be understood that other ways and methods of completing the circuit can be used, such as the clinician touching a shoulder or other part of the patient 50 using a hand 41, foot, or other body part, so long as an electrical connection is established with the patient 50 sufficient so that the clinician 40 can sense the pulsed electric current being applied to the patient 50.

In additional embodiments, a patient 50 can use the acupuncture treatment point location system 20 on their own, without assistance of a clinician, to identify strategic points such as the first strategic point 60. Iterative application of the probe tip 34 as discussed above, can also be employed. However, rather than the clinician 50 making a judgment based on the sensed pulsed current, the patient 50 can determine based on the sensed pulsed current when the first strategic point 60 has been located, by identifying the first strategic point 60 as the location in which irritation due to the pulsed electric current is least. Treatment can progress, such as via continued application of the pulsed electric current, or even self-administration of needles 44.

The above description is given by way of example, and not limitation. Given the above disclosure, one skilled in the art could devise variations that are within the scope and spirit of the invention disclosed herein. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A method of identifying an acupuncture treatment strategic point, comprising:
applying a probe to a patient's skin at a first approximate point;
applying an applied electric current to the first approximate point via the probe;
establishing electrical continuity between a clinician and the patient's skin so that the clinician can detect a sensed electric current portion of the applied electric current flowing from the patient to the clinician;
determining from the sensed electric current that the first approximate point is not a first strategic point;
moving the probe to a second approximate point; and
determining from the sensed electrical current that the second approximate point is the first strategic point.

2. The method of claim 1, wherein establishing contact between a clinician and the patient's skin comprises the clinician holding a hand of the patient.

3. The method of claim 1, additionally comprising applying a first acupuncture needle at the first strategic point.

4. The method of claim 2, additionally comprising attaching a first electrode to the first acupuncture needle and applying a stimulation current from an electrical stimulation instrument to the first acupuncture needle via the first electrode.

5. The method of claim 1, additionally comprising applying a first marker to the first strategic point.

6. The method of claim 5, additionally comprising placing a first acupuncture needle at the first precise needle site.

7. The method of claim 5, additionally comprising:
applying the probe at a third approximate point; and
determining from the sensed electrical energy that the third approximate point is a second strategic point, and applying a second marker to the second strategic point.

8. The method of claim 7, additionally comprising removing the first marker from the first strategic point and placing a first acupuncture needle at the first strategic point, and removing the second marker from the second strategic point and placing a second acupuncture needle at the second strategic point.

9. The method of claim 1, wherein the applied electric current comprises a pulsed electric current.

10. The method of claim 9, comprising modifying a frequency of the pulsed electric current.

11. The method of claim 9, comprising modifying an intensity of the pulsed electric current.
